(19) United States
(12) Patent Application Publication
(10) Pub. No.: US 2007/0273165 A1
(43) Pub. Date: Nov. 29, 2007

(54) Impact sensor

(76) Inventors: Dave Beck, West Jordan, UT (US); Thomas Danielson, Sandy, UT (US); John A. Sindt, Sandy, UT (US)

Correspondence Address: HOLME ROBERTS & OWEN, LLP, 299 SOUTH MAIN, SUITE 1800, SALT LAKE CITY, UT, 84111, US

(21) Appl. No.: 11/440,743

(22) Filed: May 25, 2006

(51) Int. Cl. B60R 19/02

(52) U.S. Cl. 293/102

(57) ABSTRACT

An impact detection system includes an impact surface mechanically associated with a vehicle and a detector mechanically associated with the impact surface. The impact surface, and hence the detector, is positioned to contact objects upon a relative movement of the vehicle with respect to the object. The detector has a deformable substrate that deflects upon the impact of the object; a resistance material deposited on the substrate, the resistance material having an electrical resistance that undergoes an ascertainable change upon deflection of the substrate from impact of the object; and conductor means connected to the resistance material to supply electrical power thereto and to transmit therefrom impact signals reflective of changes in the electrical resistance of the variable resistance material upon impact of the object with the impact surface. The impact signals can be used to determine if the object is a person or a hard object such as a pole and implement an appropriate response.

### BACKGROUND OF THE INVENTION

1. The Field of the Invention

The present invention relates to the field of sensors and more particularly to systems for detecting an object which a vehicle may impact and to generate a signal reflective thereof.

2. The Relevant Technology

Each year, thousands of people and untold numbers of animals are killed or seriously injured because they are hit by a motor vehicle (e.g. an automobile, truck, bus, etc.). Systems associated with motor vehicles are being developed to cause protective measures to be initiated on or in the motor vehicle to protect or reduce physical harm to people and animals being struck by a vehicle. For example, an automobile may have some safety device or other response that is triggered by the impact. Although the form of these impact safety devices or methods is still evolving, there is a continuing need for systems to detect a potentially harmful impact and to trigger the automated response when appropriate.

### BRIEF SUMMARY OF THE INVENTION

A first example embodiment of the invention is an impact detection system. The system generally includes a detector mechanically associated with an impact surface, for example a bumper, that is in turn mechanically associated with a vehicle and positioned to contact objects positioned in the path of the vehicle when in movement. The detector generally includes: a deformable substrate that deflects upon the impact of the object with the impact surface; a resistance material deposited on the substrate, the resistance material having an electrical resistance that undergoes an ascertainable change in electrical resistance upon deflection of the substrate upon impact of the object with the impact surface; and conductor means connected to the resistance material to supply electrical power thereto and to transmit therefrom impact signals reflective of changes in the electrical resistance of the variable resistance material upon impact of the object with the impact surface.

Another example embodiment of the invention is also an impact detector system for a vehicle. This example system generally includes: a bumper mechanically associated with a vehicle and positioned to contact objects positioned in the path of the vehicle when in movement; and a flexible potentiometer mechanically associated with the bumper. The flexible potentiometer is operable to sense the impact of an object with the bumper and configured to generate a deflection signal indicative of the impact. The flexible potentiometer generally includes: at least one sensor segment, each sensor segment having: a segment of deformable substrate; a variable resistance material formed on the segment of substrate, wherein the variable resistance material has an electrical resistance that undergoes an ascertainable change in electrical resistance upon deflection in the underlying substrate; and a conductive pathway in communication with the variable resistance material for supplying a detect signal to the variable resistance material and communicating a detect signal from the variable resistance material upon deflection of the bumper.

Yet another example embodiment of the invention is another impact detector system for a vehicle. This example generally includes: a bumper mechanically associated with a vehicle and positioned to contact an object upon a relative movement of the vehicle with respect to the object; a flexible potentiometer mechanically associated with the bumper, the flexible potentiometer being operable to sense the impact of the object with the bumper and configured to generate a deflection signal indicative of the impact. This flexible potentiometer includes: a terminal and a longitudinal member connected to the terminal and having a plurality of branch members extending therefrom, each branch member having at least part of at least one sensor segment. Each branch member includes: a segment of deformable substrate; a variable resistance material formed on the segment of deformable substrate, the variable resistance material having an electrical resistance that undergoes an ascertainable change in electrical resistance upon deflection in the underlying substrate; and a conductive pathway in communication with the variable resistance material and the terminal. The conductive pathway supplies power to the variable resistance material and communicates a detect signal from the variable resistance material upon deflection of the bumper, the conductive pathway preferably being wired to the terminal in parallel with the respective conductive pathways in each of the other sensor segments.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is to be appreciated that these drawings depict only typical embodiments of the invention and are therefore not to be considered limiting of its scope. The invention will be described and explained with additional specificity and detail through the use of the accompanying drawings in which:

FIG. 1 is block diagram depicting a deflection detection system for use with the invention;

FIG. 2 is the connector end of one form of a deflector for use with a deflection detection system;

FIG. 3 illustrates an additional section of the deflector of FIG. 2;

FIG. 4 is the connector end of another form of a deflector for use with a deflection detection system;

FIG. 5 illustrates an additional section of the deflector of FIG. 4;

FIG. 6 is a plot illustrating the typical change in resistance with deflection in a detector of the deflection detection system; and

FIG. 7 is a plot illustrating voltage changes in a detector of a deflection detection system of the invention.

### DETAILED DESCRIPTION OF THE PREFERRED EMBODIMENTS

The present invention includes means for rapidly detecting when a first object, for example a movable platform such as a vehicle, is struck by or has struck a second object and providing a signal so that it can be determined if the second object is a mammal, for example a human. The impact signal can be sent to and used by other automated systems in the movable platform to take injury preventative action.

The invention includes a deflection detection means that is connected to a deflectable surface on a movable platform where an impact is likely to occur, typically a deflectable front bumper. For example, the deflection detection means can be attached to the bumper or enclosed within the bumper. The deflection detection means preferably includes a device that changes in electrical conductivity as it is bent or deflected. Electronic systems connect to the device and measure the change in conductivity or resistance which in turn can be used to identify or classify the object impacted.

By way of example, the deflection detection means may also include a force sensitive resistor or a flexible potentiometer as described herein below, and their equivalents. Although the deflection detection means can be placed anywhere on the vehicle likely to register an impact with an object, for example a hood, grill, fender, headlight, or other structure on the vehicle, in preferred embodiments this location will be the front bumper of an automobile. The single layer design of the inventive flexible potentiometers eliminates many of the problems associated with conventional sensors such as dust, dirt, liquids, and heat and pressure affects, making it advantageous for the front of the vehicle. Over-laminates or over-molding may also be applied to the sensor for added environmental protection and for aesthetic purposes.

A data analyzer can be used to evaluate the data from the deflection detection means and determine the type of impact that has occurred. The data analyzer is in communication with the detector, although the data analyzer is not necessarily connected to the detector. The data analyzer is also in communication with any remedial safety systems that are activated as a result of a selected impact identification. Data output from the data analyzer or the detector can thereby be used to trigger a desired safety response.

Reference will now be made to the drawings to describe various aspects of exemplary embodiments of the invention. It is to be understood that the drawings are diagrammatic and schematic representations of such exemplary embodiments, and are not intended to limit the scope of the present invention. Further, the drawings are illustrative and not to be deemed drawn to scale.

In the following description, numerous specific details are set forth in order to provide a thorough understanding of the present invention. It will be obvious, however, to one skilled in the art that the present invention may be practiced without these specific details. In other instances, well-known aspects of vehicles, sensor devices, circuitry and safety systems have not been described in particular detail in order to avoid unnecessarily obscuring the present invention.

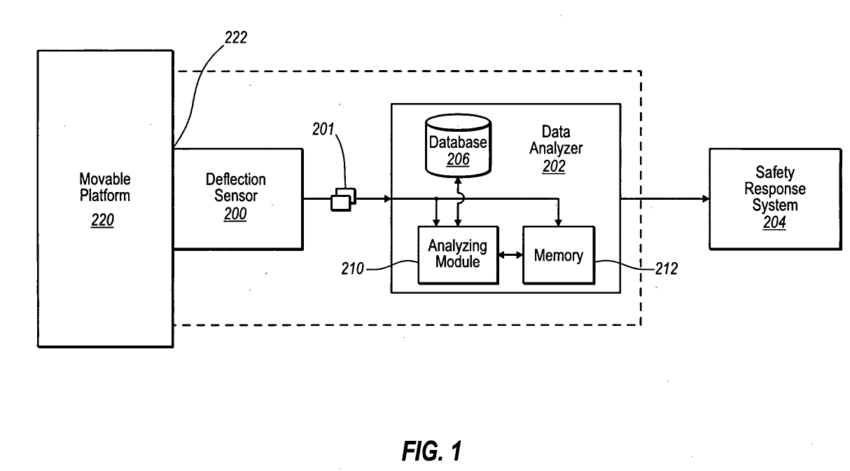

With reference now to FIG. 1, an example impact safety system includes a deflection sensor 200, as described herein below, a data analyzer 202, and a safety response system 204. The dotted line surrounding deflection sensor 200 and data analyzer 202 illustrates that deflection sensor 200 may be formed integrally with the data analyzer 202. The deflection sensor 200 is illustrated connected to a deflectable surface 222 on a movable platform 220, e.g. a bumper. In use, a deflection detection means is preferably placed on a surface of a bumper or other impact surface. The bumper and hence the deflection detection means are thereby configured to correspondingly mechanically deflect upon application of the force or pressure to the bumper.

As described elsewhere herein, deflection signal 201 is generated by the deflection sensor 200 upon sensing an impact at the deflectable surface on a movable platform 220. Deflection signal 201; collected from deflection sensor 200 is then communicated by connector means, e.g. by internal circuitry, by a conductive connection within a movable platform, or wirelessly, to an analysis means for evaluating whether a safety response should be taken, for example data analyzer 202.

Generally, the data analyzer 202 may include a database 208 with look up tables, formulas, or other data that can be used by analyzing module 210 to analyze deflection signal 201 and determine if the deflection signal 201 represents a soft tissue, e.g. pedestrian, impact. Non volatile memory 212 (optionally containing database 208) is preferably also used to store forensic data or other information of interest. In the event that the analyzing module 210 determines that a pedestrian impact has occurred, that information is communicated to safety response system 204 so that any desired safety actions can be taken. Such safety actions, and the necessary systems and devices to implement the actions, include those currently known in the art or later generated or disclosed that require a rapid pedestrian impact notification.

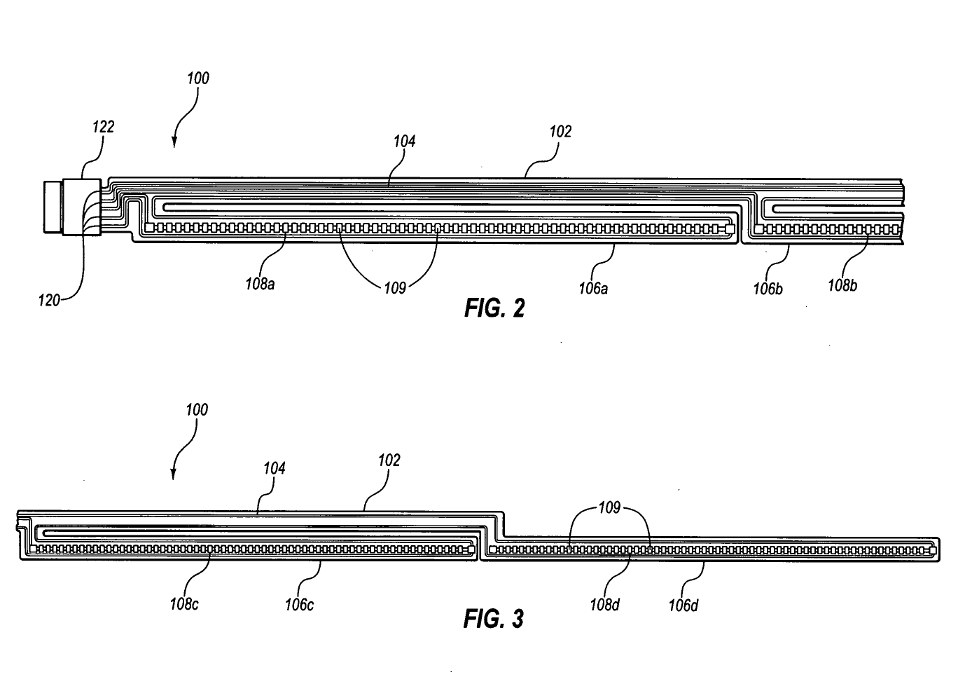

With reference now to FIGS. 2-5, the detector can be an improved flexible potentiometer 100, 150. Conventional flexible potentiometers are available and marketed under the mark Bend Sensor® by Sensitron, Inc., located at 106 West 12200 South, Draper, Utah 84020, and as more fully described in U.S. Pat. No. 5,157,372 (Langford) and U.S. Pat. No. 5,583,476 (Langford) the disclosures of which are incorporated herein by this reference. The flexible potentiometer is a sensor of the type which predictably changes a measurable electrical characteristic upon the application of a force thereto. A flexible potentiometer uses a variable resistance material which predictably changes electrical resistance upon deflection or bending between a first configuration and a second configuration. A resistive grid associate with the flexible potentiometer may be used to measure a degree or angle of deflection.

Power is supplied to a flexible potentiometer through a conductor means (e.g. conductive pathways 104), across a variable resistance material 108A-108D, and back to another segment of the conductor means. The conductor means is thus connected to the variable resistance material to supply electrical power thereto and to transmit therefrom signals reflective of changes in the measurable electrical characteristic of the variable resistance material. The variable resistance material is formed of an electrically conductive ink which predictably changes electrical resistance upon deflection or bending between a first configuration and a second configuration. When the resistance across the variable resistance material changes with a deflection, the resultant voltage changes (or current changes) can be detected in accompanying circuitry and a deflection can thus be identified and quantified.

The terminal means e.g. terminal 122) is conductively connected to the conductor means both to provide a source of electrical power and also to receive a signal from the conductor means reflective of the changes in the measurable electrical characteristic of the variable resistance material. The received signal can be used to generate a deflection signal or relayed to an external circuit or data repository configured to receive the signal.

As described in greater detail below, the detector can be configured not only as a continuous sensor that detects a deflection anywhere along its length, but also as a series of sensors that can be used to isolate the location of the deflection.

According to the invention, a flexible potentiometer is preferably positioned lengthwise on the front bumper of an automobile. In one arrangement, the flexible potentiometer has a plurality of sensors with each sensor being positioned on a corresponding section of the bumper surface such that each sensor mechanically deflects upon deflection of the underlying section of the bumper surface. Thus, this example device can be used to isolate the impact.

As illustrated in FIGS. 2 and 3 (FIGS. 2 and 3 depict terminal ends of the same sensing device), in a preferred configuration a series of flexible branches 106A-106D extend from a base 102 to provide a series of sensors. Individual sections of variable resistance material 108A-108D are formed on each branch, with accompanying conductive pathways 104 connected thereto, so that each branch can be used as a separate sensor for isolated deflection detection in the event each branch is wired in parallel to one another. Each branch in this case therefore only detects deflection along its section of variable resistance material 108A-108D, with a greater number of sensors providing greater detail into the location of a deflection. Any number of such branches can be used, for example 1, 2, 3, 6 or 8. Each branch can vary in length, for example from about 1 inch to 3 feet or more, although about six inches is a preferred length.

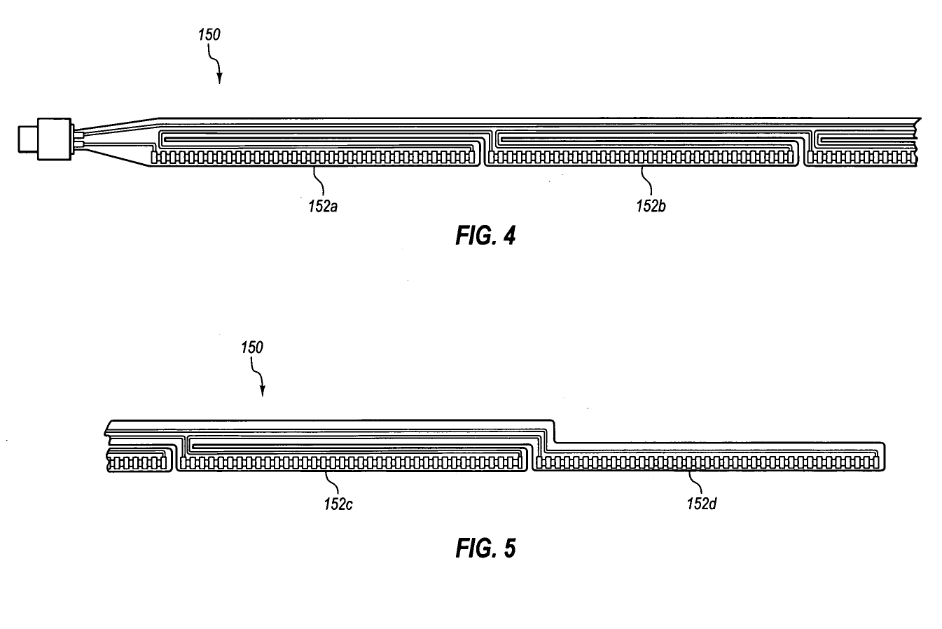

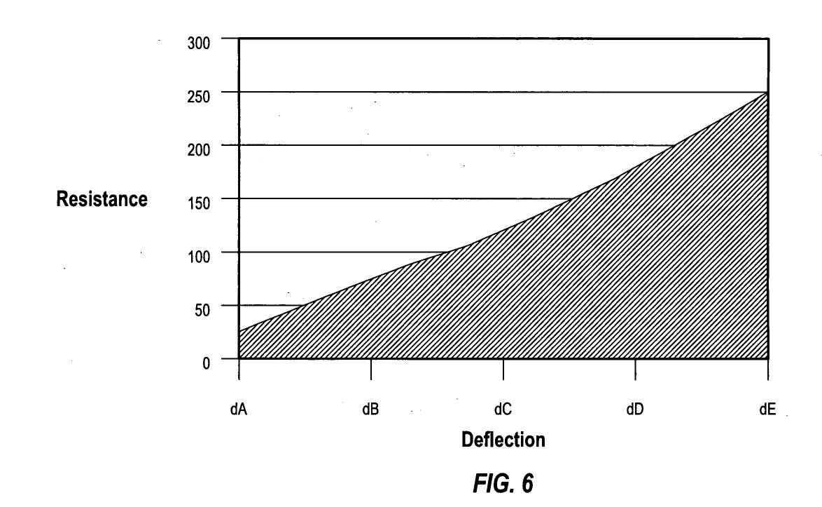

In other embodiments an as illustrated in FIGS. 4 and 5, the detector can be a continuous sensor. Such a continuous sensor may or may not include branches 152a-152d in the design, the embodiment having multiple branches being shown in FIGS. 4 and 5 (FIGS. 4 and 5 illustrate terminal ends of the same device). The use of a plurality of branches, wired in series, may be preferred to a design lacking branches because a continuous sensor having shorter sections of variable resistance material may more easily sense a deflection thereto as the relative amount of deflection is greater as the ratio of deflection to length increases.

The variable resistance material may be formed of an electrically conductive ink which predictably changes electrical resistance upon deflection or bending between a first configuration and a second configuration. The variable resistance material is preferably deposited on one surface of the base along a portion of the width and longitudinally along an axis. The conductive ink can be deposited on a substrate such as the base by means comparable to silk screening or printing. Appropriate conductive inks suitable for the present embodiments include graphite with binders. Suitable inks are available at Flexpoint, Inc. of Salt Lake City, Utah.

Segmented constant resistance conductive material may be used in combination with a flexible potentiometer to reduce the resistance and help linearize changes in resistance. The segmented conductors 109 may be made of silver, silver alloys, or other conductive metals, as well as conductive carbon-based compounds. The segmented conductors 109 may be applied in a liquid form, or applied in a solid form which is pressed onto the variable resistance material. The conductivity of the segmented conductors 109 remains essentially constant upon deflection. Therefore, the segmented conductors 109 provide paths for electrical current that are in parallel with the path provided by the variable resistance material. The segmented conductors 109 act as attenuators.

The base and the branches are each formed as part of a substrate upon which the variable resistance material is formed. Preferably, the variable resistance material is formed along a longitudinal axis of a section of the substrate such that as the corresponding section of substrate deflects about a transverse axis, the variable resistance material is deflected with the substrate about the transverse axis.

The substrate is formed of an insulating material that is flexible over a wide range of temperatures (e.g., from about −30° F. to about 150° F.) while at the same time being preferably thin and light weight. Any polyimide material in general will be suitable. Various forms of polyethelene, polyester, polyethylene terapthalate and polyethylene napthalate (PEN) may also be suitable. However, KAPTON™ material has been found particularly suitable. KAPTON™ is commercially available from E. I. Dupont de Nemours & Company of Wilmington Del. By way of example only, the substrate may be from about 0.003 to about 0.01 inches in thickness (although various other thicknesses may be acceptable); the variable resistive material may be from about 0.0005 to about 0.0015 inches in thickness (although various other thicknesses may be acceptable). The variable resistance material and any conductors to which it is connected may be covered with an insulating material which is attached to by an adhesive to effect a seal to create a detector that is immersible in liquids and protected from dust and small physical hazards. A polyimide material has been found to be suitable as an insulating material. A polyester material may also be suitable. Various materials used for “potting” electronic components may be used. With an insulating material placed over the conductors, the device can be water resistant because it has the conductors sealed within and between the base material and the cover material.

The terminal means (e.g. terminal 122) is connected and provides power to the conductor means (e.g. conductive pathways 104). With reference to FIG. 2, the value of the resistance of the variable resistance material (or other electrical parameter) can be measured by terminal 122 or related circuitry through conductors 120. Terminal 122 or related determining circuitry that is connected, to the detector may generate a deflection signal indicative of a value of the resistance of the variable resistance material and determine whether the detector is deflecting within the particular range based on the indicative signal. The determining circuitry may respond to merely the presence of deflection, that the deflection exceeds a threshold, or to a particular value of a threshold. In each case, the deflection is within a range.

In one embodiment of the invention the voltage drop across the sensors is detected by a voltage detection circuit, the output of which is supplied to an analog-to-digital converter (A/D). A microprocessor and/or dedicated hardware circuitry interprets the digital voltages to decide the extent of deflection if any. The magnitude of the deflection is related to the magnitude of the voltage. The magnitude of an impact may be related to the magnitude of the deflection. Alternatively, the conductor may be connected directly to the A/D or directly to dedicated hardware circuitry. Dedicated hardware circuitry may be analog and/or digital.

In operation, it should be understood that the signals from the sensors are not necessarily continuously read but rather may be sampled periodically at a rate. By way of example, the inputs can be sampled (in groups of 8) every 16 mili-seconds. The output is supplied to a processor that is programmed as desired to receive the digital input and evaluate it against predetermined criteria to determine what has impacted the automobile.

This relationship between deflection and resistance is illustrated generally in FIG. 6, where the relation between deflection and resistance is plotted to demonstrate how an increase in deflection, or bend, leads to a measurable increase in resistance. The rate of change in resistance of variable resistance material, as seen in the values or changes in values of voltages can be used to distinguish between types of impacting materials.

Thus, according to the invention a variety of impact materials can be tested in impact on a given deflectable surface such as a bumper. A single voltage determining circuit and A/D (or current detectors) could be used by switching between conductors. Correlating data or equations and the like can then be generated and stored in the form of a look up table or an equation that can be stored in database 206. It may also have to be factored in how much force is absorbed by the body of the automobile. The force absorbed by particular automobiles may be gathered by automobile manufacturers. In addition, the look up table or equation may have variables depending on what part of a vehicle is struck and its speed. Data can be gathered empirically through comparing the values of voltages on conductors during various impacts. In short, various analyses could be used as well as various existing or yet to be obtained data for use by the data analyzer 202.

The analyzer module 210 may be configured to receive signals directly from the deflection detection system. By way of example, the analyzer module 210 may include an ASIC (Application Specific Integrated Circuit) as described in U.S. Pat. No. 6,497,430, which is incorporated herein by reference in its entirety. Such an example ASIC can include an analog to digital converter (A/D converter) which also is configured to supply multiplexed signals to an 8 bit analog to digital converter. The A/D converter supplies signals to an 8 bit micro processor. The ASIC also has bytes of SRAM and 8 kilobytes to 16 kilobytes of OTP ROM. The ASIC receives the analog input from the several sensors from the terminal via appropriate conductors while supplying a serial EEPROM signal and a signal to an LED display. The ASIC also supplies a signal to a one wire GM (General Motors) bus. Power is provided along with a high/low signal at input; and a calibration signal is provided at output. Deflection values and other data such as vehicle speed, date and time may be stored in memory 212 for forensic purposes.

In embodiments of the invention, data analyzer 202 can include or be incorporated in computer-readable media having computer-executable instructions or data structures stored thereon. Examples of computer-readable media include RAM, ROM, EEPROM, CD-ROM or other optical disk storage, magnetic disk storage or other magnetic storage devices, or any other medium capable of storing instructions or data structures and capable of being accessed by a general purpose or special purpose computer. Computer-readable media also encompasses combinations of the foregoing structures. Computer-executable instructions include, for example, instructions and data that cause a general purpose computer, special purpose computer, or special purpose processing device to execute a certain function or group of functions. The computer-executable instructions and associated data structures represent an example of program code means for executing the steps of the invention disclosed herein. Those skilled in the art will understand that the invention may be practiced in computing environments with many types of computer system configurations as are currently known in the art or will be made known or developed hereafter.

Accordingly, a method of detecting and defining an impact of an object on a vehicle can include providing collision profile data in memory, wherein the collision profile data relates to at least one deflection data pattern that results from at least one form of collision; receiving deflection signals indicative of a deflection on a detector as described elsewhere herein, and comparing the data indicative of the deflection to the collision profile data to determine whether the object is a person. The determination of whether the object is a person can then be used to trigger a safety response device to implement a safety response to reduce the harm to the impacted person. A computer program product including a computer readable medium carrying computer executable instructions can be used to perform this method.

The systems of the invention can receive power from a source such as a separate battery or the automobile battery and supplies it via conductors to a battery voltage sensor. The power is also supplied via conductor to a power supply. The circuitry showing power distribution is not shown for clarity.

The system may include more than one detector, each having an electrical parameter that changes upon deflection of the detector for detecting deflections in various directions. The detectors may be joined in a group or separated. The determining circuitry may generate signals indicative of values of electrical parameters of the additional detectors and determine whether the detectors are deflecting within particular ranges based on the indicative signals.

Embodiments of the invention may also be practiced outside the context of vehicles. Other systems where not only impact detection, but characterization of the impacted or impacting object as well are useful can benefit from the current invention.

### EXAMPLE 1

A pendulum impact tester was used to test the ability of the inventive systems to distinguish between steel impact and soft tissue impact and to determine the best construction for an impact sensor. Some of the criteria considered were response time and sensor behavior during the use of a leg form and a hard post.

A leg form was constructed following EEVC guidelines (European Enhanced Automobile-safety Committee, Working Group 17 dated December 1998 with September 2002 updates, incorporated herein by reference). The leg was constructed only from the knee joint down. A steel post for testing was constructed using the same 70 mm diameter tube and weighted to be equal with the leg form. A bumper block was provided and was an EPP foam with a density of 1.9 pounds per cubic foot. The bumper had a fascia of 0.125″ (3 mm) thick ABS plastic. A pendulum was used to impact the leg form and steel post into the bumper block. The pendulum was a steel “A” frame construction with an arm length of 127″ from the pivot to the impact zone of the bumper. Tests were conducted at approximately 25 km/h and 40 km/h.

A detector having four independent sensor elements was attached to the side of the bumper block opposite the point of impact from the leg form or hard post. A membrane switch was used in order to determine the reaction time of the detector. The membrane switch was attached to the front fascia to trigger the moment the post touched the bumper. Using two channels on the oscilloscope, one channel monitored the switch and the other channel monitored the detector. The time interval was then observed. The test circuit was a voltage divider with the detector and a resistor connected to 5VDC. An increase in sensor resistance is reflected in an increased sensor voltage up to the limit of 5VDC.

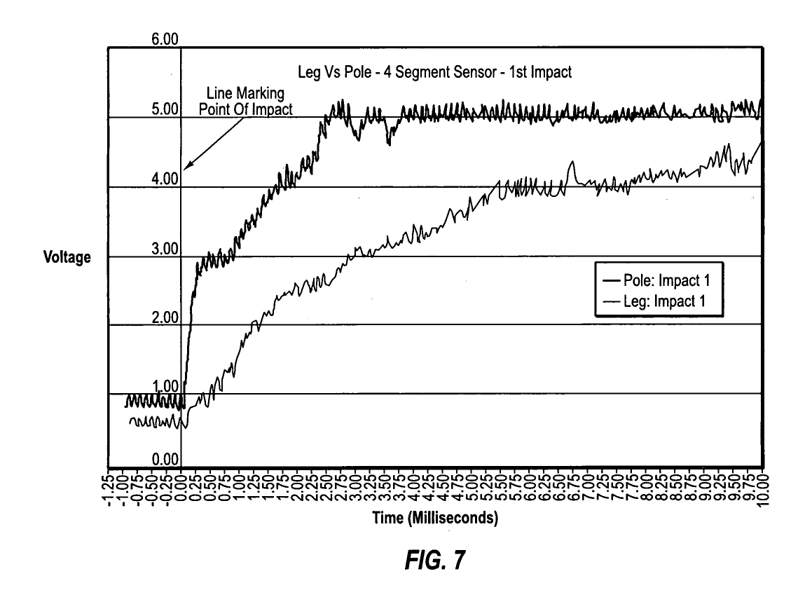

With reference now to FIG. 5, the x axis of the graph is time measured in milliseconds. At t=0 is the moment, the striking device, leg or steel pole, closed the membrane switch on the surface of the bumper fascia. This is common for all impacts in the test. FIG. 7 illustrates the differences seen in the results of the impacts. To be noted is the difference in slope between the two series of lines. The steel pole transfers energy much quicker which is readily apparent in the steeper slope.

The tests were also conducted at both approximately 25 km/h and approximately 40 km/h to determine if the results can be determined at both high and low speeds. It was determined that the objects can be determined at both speeds and that impacts have a much different signature at lower speeds as well. Accordingly, speed information can also be used to evaluate the type of impact.

The use of terms such as “persons,” “humans,” “vehicles,” and “automobiles” have been used for convenience and is not intended to limit the scope of the invention. It will be apparent to those skilled in the art in view of the disclosure herein how the invention can apply in various embodiments.

As used in the claims, the term “connect,” “connectable,” or “connected to” are not necessarily limited to a direct connection. The context is useful in determining the intent.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An impact detection system comprising:
an impact surface mechanically associated with a vehicle; and
a detector mechanically associated with the impact surface, said detector having:
a deformable substrate that deflects upon the impact of an object with said impact surface;
a resistance material deposited on the substrate, the resistance material having an electrical resistance that undergoes an ascertainable change in electrical resistance upon deflection of the substrate upon impact of the object with said impact surface; and
conductor means connected to the resistance material to supply electrical power thereto and to transmit therefrom impact signals reflective of changes in said electrical resistance of the variable resistance material upon impact of the object with said impact surface.

2. The system of claim 1, wherein the deformable substrate is elastically deformable.

3. The system of claim 1, wherein the impact surface is a bumper.

4. The system of 1, wherein the deformable substrate extends along the length of the impact surface of said deformable substrate.

5. The system of claim 4, wherein the deformable substrate has branch members extending therefrom, each branch member being formed into a sensor with a portion of said resistance material deposited thereon.

6. The system of claim 5, wherein the impact surface is a bumper and the sensors on the branch members are wired in parallel so it can be determined upon impact which sensors, and hence which sections of the bumper, have been impacted.

7. The system of claim 1, wherein the substrate is elastically deformable.

8. The system of claim 1, wherein the vehicle is an automobile.

9. The system of claim 1, wherein the impact signals generated by said detector are continuously generated at a rate sufficient that impact signals can be used to determine the rate of deflection of the substrate.

10. The system of claim 9, wherein an impact signal is generated by said detector at least once every 100 mili-seconds.

11. The system of claim 9, wherein an impact signal is generated by said detector at least once every 16 mili-seconds.

12. An impact detection system for a vehicle, said impact detection system comprising:
a bumper mechanically associated with a vehicle and positioned to contact objects positioned in the path of said vehicle; and
a flexible potentiometer mechanically associated with the bumper, said flexible potentiometer being operable to sense the impact of an object with said bumper and configured to generate a deflection signal indicative of said impact, said flexible potentiometer including at least one sensor segment, each sensor segment comprising:
a segment of deformable substrate,
a variable resistance material formed on the segment of substrate, wherein the variable resistance material has an electrical resistance that undergoes an ascertainable change in electrical resistance upon deflection of the underlying substrate, and
a conductive pathway in communication with the variable resistance material for supplying electrical power to the variable resistance material and communicating a detect signal from the variable resistance material upon deflection of said bumper.

13. The system of claim 12, wherein the flexible potentiometer comprises a longitudinal member having a plurality of branch members extending therefrom, each branch member having at least part of at least one sensor segment.

14. The system of claim 13, wherein the conductive pathways for the branch members are wired in parallel such that it can be determined upon impact which sensors, and hence which sections of said bumper, have been impacted.

15. The system of claim 13, wherein the conductive pathways for the branch members are wired in series.

16. The system of claim 12, wherein the variable resistance material is a conductive ink deposited on the substrate.

17. The system of claim 12, wherein the resistance of said variable resistance material is sampled at a frequency sufficient that the detect signals can be used to determine the amount of, and the rate of, deflection of the substrate.

18. An impact detection system for a vehicle, said impact detection system comprising:
a bumper mechanically associated with a vehicle and positioned to contact an object upon a relative movement of said vehicle with respect to said object; and
a flexible potentiometer mechanically associated with said bumper, said flexible potentiometer being operable to sense the impact of the object with said bumper and configured to generate a deflection signal indicative of said impact, said flexible potentiometer including:
a terminal; and
a longitudinal member connected to said terminal and having a plurality of branch members extending therefrom, each branch member having at least part of at least one sensor segment, each branch member comprising:
a segment of deformable substrate;
a variable resistance material formed on the segment of deformable substrate, wherein the variable resistance material has an electrical resistance that undergoes an ascertainable change in electrical resistance upon deflection in the underlying substrate; and
a conductive pathway in communication with the variable resistance material and the terminal for supplying power to the variable resistance material and communicating a detect signal from the variable resistance material upon deflection of said bumper, the conductive pathway being wired to the terminal in parallel with the respective conductive pathways in each of the other sensor segments.

19. The system of claim 18, wherein the variable resistance material is a conductive ink deposited on the substrate.

20. The system of claim 18, wherein the resistance of said variable resistance material is sampled at a frequency sufficient that the detect signals can be used to determine the rate of deflection of the substrate.
